(19) United States
(12) Patent Application Publication
(10) Pub. No.: US 2015/0214809 A1
(43) Pub. Date: Jul. 30, 2015

(54) Motor with Thrust Bearing

(71) Applicant: Sunonwealth Electric Machine Industry Co., Ltd., Kaohsiung City (TW)

(72) Inventors: Alex Horng, Kaohsiung City (TW); Yeh-Feng Chen, Kaohsiung City (TW)

(21) Appl. No.: 14/552,625

(22) Filed: Nov. 25, 2014

(30) Foreign Application Priority Data
Jan. 27, 2014 (TW) 103102988

(51) Int. Cl. H02K 5/16; F16C 41/00; H02K 7/08; F16C 35/02

(52) U.S. Cl. CPC H02K 5/165; F16C 35/02; F16C 41/004; H02K 7/088

(57) ABSTRACT

A motor includes: a base having a bearing sleeve, with the bearing sleeve having an opening end and a sealing end, with the opening and sealing ends opposite to each other; a stator coupled with the base; a rotating member rotatably received in and coupled with the bearing sleeve, with the rotating member comprising a shaft and a limiting portion, wherein a first end of the shaft connects with the limiting portion, a second end of the shaft has a coupling portion; a thrust bearing arranged between the shaft and an inner surface of the bearing sleeve, so that the limiting portion is between the thrust bearing and the sealing end; a pressing member coupled with the bearing sleeve and received therein for positioning the thrust bearing; and a hub coupled with the coupling portion of the shaft and having a permanent magnet corresponding to the stator.

### BACKGROUND OF THE INVENTION

1. Field of the Invention

The present invention generally relates to a motor with thrust bearing and, more particularly, to a motor able to steadily position the thrust bearing via pressure.

2. Description of the Related Art

Referring to FIG. 1, a sketch diagram of a conventional motor with a thrust bearing is shown, which is identified with a reference number of “9” and has a seat 91, a stator 92 and a rotor 93. The seat 91 is coupled with a bearing housing 911 receiving a thrust bearing 912 and a pushing board 913 inside. The bearing housing 911 has two opposite openings for the rotor 93 to extend into the thrust bearing 912 and to couple with a lid 914 respectively. The stator 92 is coupled with an outer periphery of the seat 91. The rotor 93 includes a hub 931 integrally forming an annular wall 932 and a shaft 933. The annular wall 932 is located between the seat 91 and the bearing housing 911, so as to provide functions such as dust-resistance and anti-leakage of oil. The shaft 933 extends through the thrust bearing 912 and is coupled with the pushing board 913. Specifically, this kind of motor 9 is disclosed in patents such as a China patent application with the application number of 200410054614.4 (which is U.S. Pat. No. 7,021,829) and title of “Fluid-Dynamic-Pressure Bearing, Spindle Motor Furnished with the Fluid-Dynamic-Pressure Bearing, Method of Manufacturing Rotor Assembly Applied in the Spindle Motor, and Recording-Disk Drive Furnished with the Spindle Motor.”

With the thrust bearing 912 coupled with the bearing housing 911, the thrust bearing 912 can delimit the movement of the pushing board 913, so as to avoid the rotor 93 disengaging from the bearing housing 911. However, since the conventional motor 9 lacks of a member inside the bearing housing 911 for further fixing the thrust bearing 912, the thrust bearing 912 may not by able to delimit the movement of the pushing board 913 if the thrust bearing 912 is not firmly positioned therein. Furthermore, there can be an oil-leakage problem in this motor 9, which can lead to a short lifetime of the motor 9, since the bearing housing 911 does not equip any member at the opening for oil preservation. Therefore, it is necessary to improve the conventional motor 9.

### SUMMARY OF THE INVENTION

What is needed is a motor with thrust bearing able to firmly press and position the thrust bearing.

Another need is a motor with thrust bearing able to improve oil preservation for the thrust bearing.

In one implementation, a motor with thrust bearing includes: a base having a bearing sleeve, with the bearing sleeve having an opening end and a sealing end, with the opening and sealing ends opposite to each other; a stator coupled with the base; a rotating member rotatably received in and coupled with the bearing sleeve, with the rotating member comprising a shaft and a limiting portion, wherein a first end of the shaft connects with the limiting portion, a second end of the shaft has a coupling portion; a thrust bearing arranged between the shaft and an inner surface of the bearing sleeve, so that the limiting portion is between the thrust bearing and the sealing end; a pressing member coupled with the bearing sleeve and received therein for positioning the thrust bearing; and a hub coupled with the coupling portion of the shaft and having a permanent magnet corresponding to the stator.

In this implementation, one or more of the following features may be included: a support is arranged inside the bearing sleeve and between the thrust bearing and the sealing end, with the thrust bearing abutting against the support; a gap is formed between the limiting portion and the thrust bearing; the support is in a ring shape and surrounds the limiting portion, and a gap is formed between the limiting portion and an inner surface of the support; the support is integrally formed with an end face of the thrust bearing; the support is integrally formed with the inner surface of the bearing sleeve; the sealing end has a groove in the bearing sleeve, and the support is mounted in the groove; the pressing member is in a plate shape and is coupled with the inner surface of the bearing sleeve by press fit; an axial height of the pressing member is smaller than or equal to an axial height of the limiting portion; the pressing member has a plate and an annular flange, the annular flange connects with an outer edge of the plate and engages with the inner surface of the bearing sleeve by press fit; an axial height of the annular flange is larger than or equal to an axial height of the limiting portion; in radial directions of the rotating member, each of the shaft and limiting portion has a maximum outer diameter, and the maximum outer diameter of the limiting portion is larger than the maximum outer diameter of the shaft; the base further has a plate integrally formed or detachably coupled with the bearing sleeve; a wear pad is disposed in the bearing sleeve on an inner side of the sealing end, and the rotating member abuts against the wear pad.

### BRIEF DESCRIPTION OF THE DRAWINGS

The present invention will become more fully understood from the detailed description given hereinafter and the accompanying drawings which are given by way of illustration only, and thus are not limitative of the present invention, including:

FIG. 1 is a sketch diagram of a conventional motor with thrust bearing.

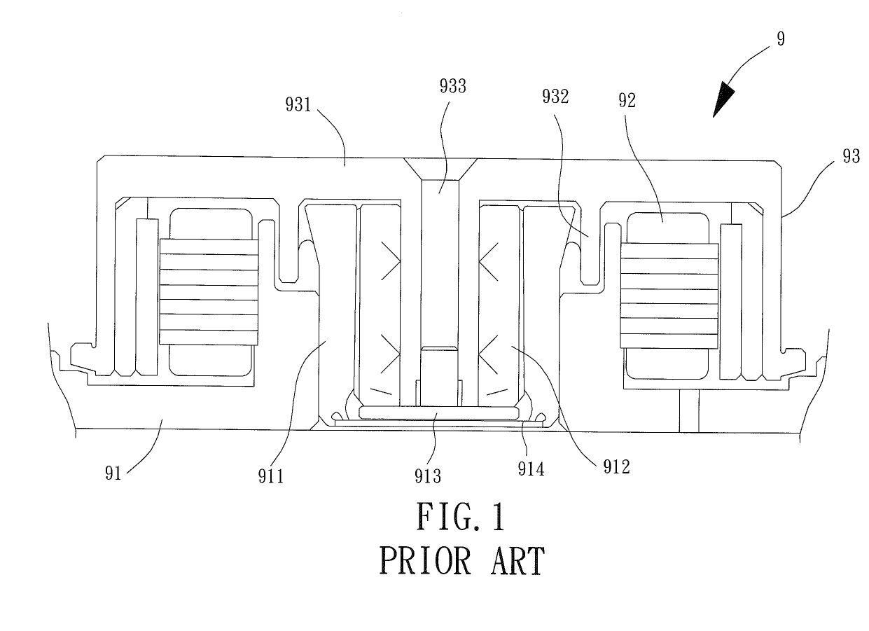

FIG. 2 is a cross-sectional view of a motor with thrust bearing according to a first embodiment of the present disclosure.

FIG. 3 is a cross-sectional view of a motor with thrust bearing according to a second embodiment of the present disclosure.

FIG. 4 is a cross-sectional view of a motor with thrust bearing according to a third embodiment of the present disclosure.

FIG. 5 is a cross-sectional view of a motor with thrust bearing according to a fourth embodiment of the present disclosure.

In the various figures of the drawings, the same numerals designate the same or similar parts. Furthermore, when the term “first,” “second,” “inner,” “outer” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

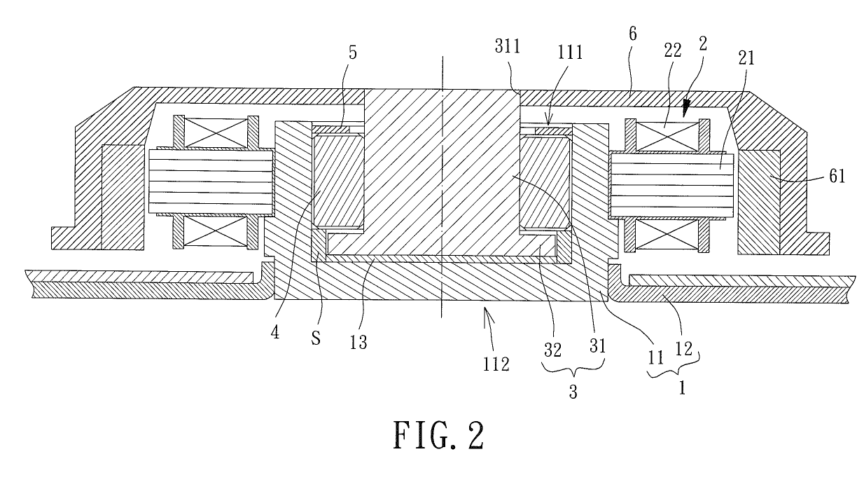

Referring to FIG. 2, a preferred embodiment of a. motor with thrust bearing of the present invention is shown, which includes a base 1, a stator 2, a rotating member 3, a thrust bearing 4, a pressing member 5, and a hub 6. The stator 2 is coupled with the base 1, the rotating member 3 is rotatably coupled to the base 1 through the thrust bearing 4, the pressing member 5 presses and positions the thrust bearing 4, and the hub 6 is coupled with the rotating member 3.

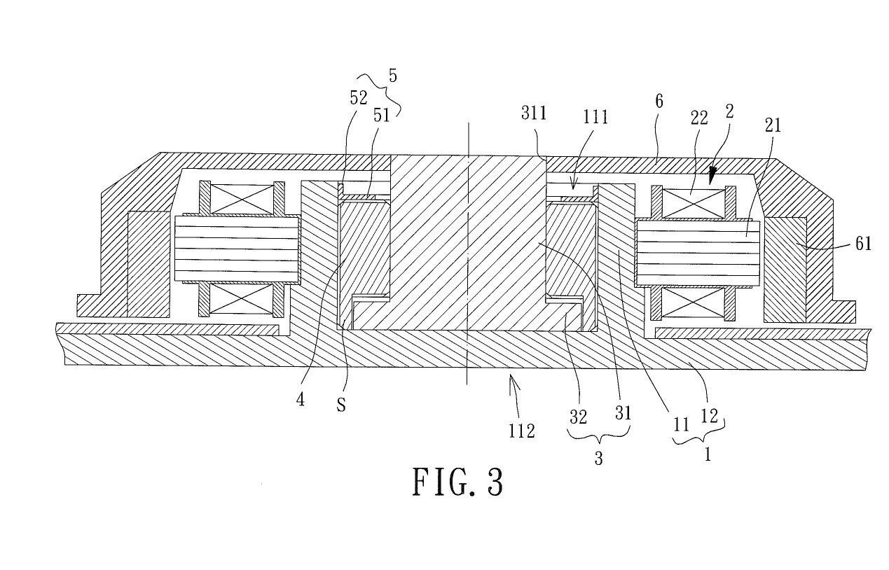

The base 1 has a bearing sleeve 11 and may also include a plate 12, with the bearing sleeve 11 and the plate 12 detachably connecting with each other as shown in FIG. 2 or integrally formed with each other as shown in FIG. 3. The bearing sleeve 11 may be made of plastic for easy formation, and the plate 12 may be made of metal for enhanced strength of the base 1. However, materials for the bearing sleeve 11 and the plate 12 are not thus limited.

Specifically, the bearing sleeve 11 can be of any structure capable of receiving the rotating member 3 and the thrust bearing 4. The bearing sleeve 11 has an opening end 111 and a sealing end 112, with the sealing end 112 coupled to the plate 12. The sealing end 112 may connect with a periphery wall of the bearing sleeve 11; alternatively, the sealing end 112 may be formed by coupling a lid to an end opening of the periphery wall opposite to the opening end 111. Preferably, a wear pad 13 is disposed in the bearing sleeve 11 on an inner side of the sealing end 112 for supporting the rotating member 3, so that the rotating member 3 can rotate smoothly.

The stator 2 is coupled with the bearing sleeve 11 or the plate 12 of the base 1 and is in a structure for driving the hub 6. Preferably, the stator 2 is arranged around the bearing sleeve 11 and coupled with an outer periphery of the bearing sleeve 11. The stator 2 includes a silicon steel member 21 and a coil 22 winding around the silicon steel member 21. The silicon steel member 21 can be in the form of a pile of silicon steel plates or a single silicon steel plate.

The rotating member 3 is rotatably received in and coupled with the bearing sleeve 11 and includes a shaft 31 and a limiting portion 32, the limiting portion 32 is integrally formed at or detachably connects to a first end of the shaft 31, and a second end of the shaft 31 has a coupling portion 311. Specifically, the rotating member 3 is rotatably received in and coupled with the bearing sleeve 11 in a way that the coupling portion 311 is close to the opening end 111 but away from the sealing end 112 as well as the limiting portion 32 is close to the sealing end 112 but away from the opening end 111. Particularly, in radial directions of the rotating member 3, which are perpendicular to an axial direction of the rotating member 3, each of the shaft 31 and the limiting portion 32 has. a maximum outer diameter, and the maximum outer diameter of the limiting portion 32 is preferably larger than that of the shaft 31.

The thrust bearing 4 is also disposed in the bearing sleeve 11 and between the shaft 43 and an inner surface of the bearing sleeve 11. Therefore, with the thrust bearing 4, the rotating member 3 can stably rotate inside the bearing sleeve 11. Besides, the limiting portion 32 can extend into a gap between the thrust bearing 4 and the sealing end 112, and can be axially positioned therein since the maximum outer diameter of the limiting portion 32 is preferably larger than that of the shaft 31. Therefore, the rotating member 3 does not easily fall out of the bearing sleeve 11.

Preferably, inside the bearing sleeve 11, a support “S” is arranged at the sealing end 112 for supporting the thrust bearing 4. The support “S” may be in a ring shape, surround the limiting portion 32, and may be arranged between the thrust bearing 4 and the sealing end 112. Moreover, it is preferable that there is a gap between the limiting portion 32 and an inner surface of the support “S” so as to avoid the support “S” interfering rotation of the rotating member 3. Therefore, with the support “S” having an axial height larger than that of the limiting portion 32, an axial gap between the thrust bearing 4 and the wear pad 13 is slightly larger than the axial height of the limiting. portion 32, such as providing a gap between the. thrust bearing 4 and the limiting portion 32, so that the rotating member 3 can rotate without interference of the thrust bearing 4.

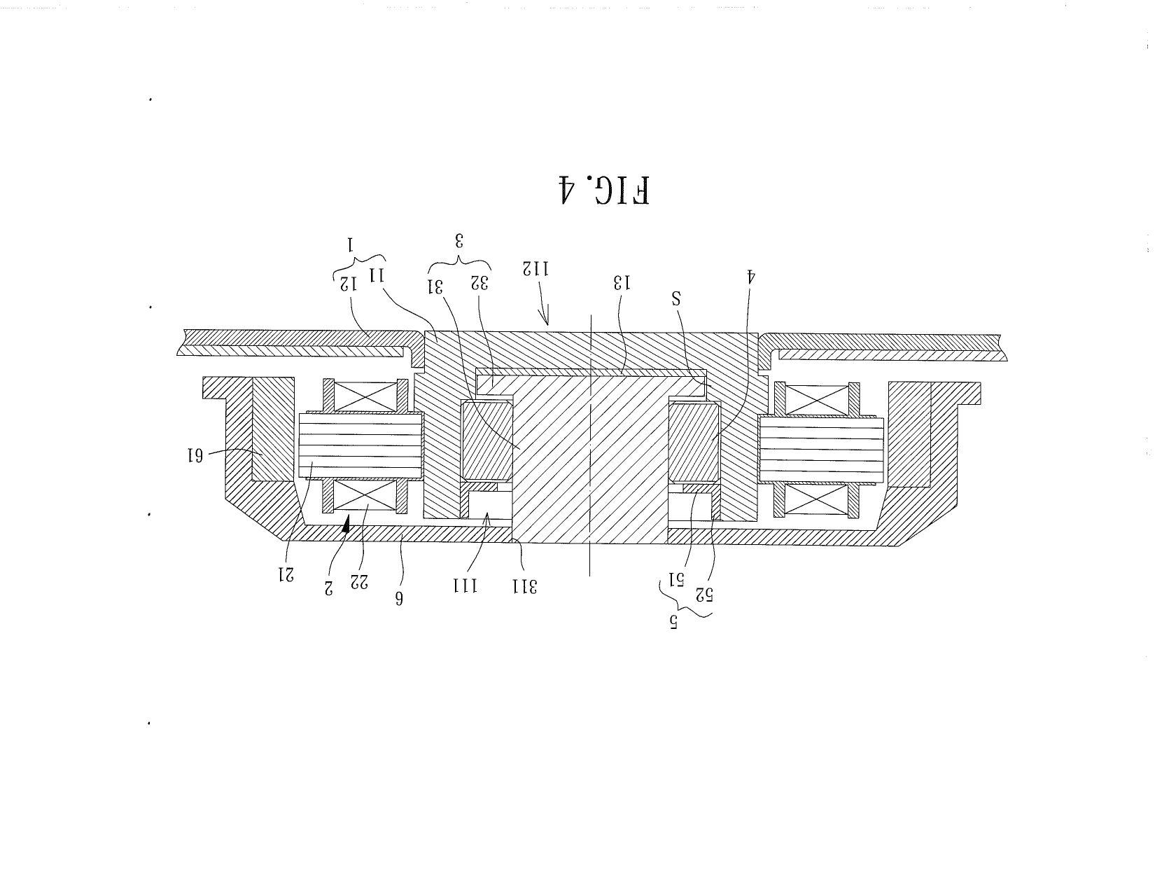

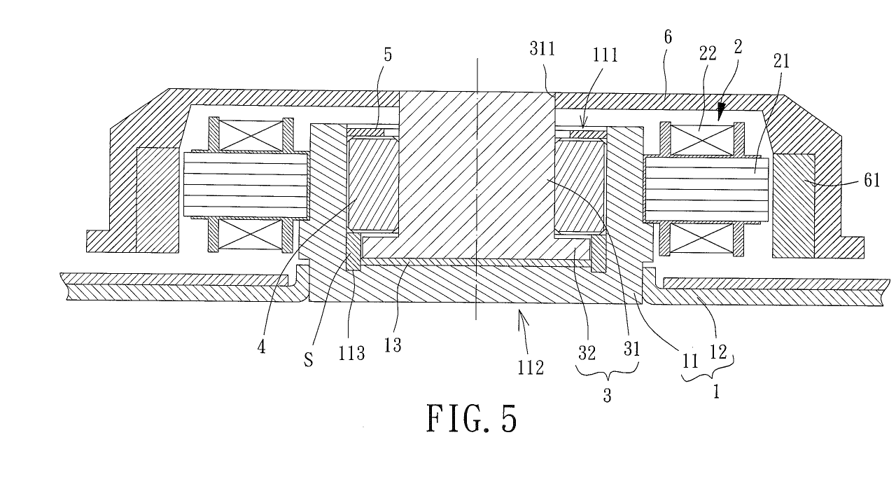

Based on the above idea about the support “S,” the support “S” may be integrally formed on the thrust bearing 4 as shown in FIG. 3 or integrally formed in the bearing sleeve 11 as shown in FIG. 4. Furthermore, referring to FIG. 5, the sealing end 112 may further have a groove 113 in the bearing sleeve 11 for the support “S” to be mounted therein, so as to firmly keep the support “S” inside the bearing sleeve 11.

The pressing member 5 is coupled with the bearing sleeve 11 and is received therein, which is adapted to axially press the thrust bearing 4 so as to fix the thrust bearing 4 inside the bearing sleeve 11. As shown in FIG. 2, the pressing member 5 may be in a plate shape and is coupled with the inner surface of the bearing sleeve 11 by press fit. Preferably, an axial height of the pressing member 5 is smaller than or equal to the axial height of the limiting portion 32, so that the bearing sleeve 11 does not need to increase too much in axial height for the pressing member 5.

Alternatively, as shown in FIG. 3, the pressing member 5 may include a plate 51 and an annular flange 52, with the annular flange 52 connecting with an outer edge of the plate 51 and engaging with the inner surface of the bearing sleeve 11 by press fit, so that an engaging. area as well as the combination stability between the pressing member 5 and the bearing sleeve 11 is largely increased. Moreover, an axial height of the annular flange 52 may be larger than or equal to the axial height of the limiting portion 32, so that the combination stability between the pressing member 5 and the bearing sleeve 11 can be further improved.

The hub 6 can be coupled with the coupling portion 311 of the shaft 31 by a conventional way such as welding, adhesion, screwing, or press-fitting. The hub 6 has a permanent magnet 61 corresponding to the stator 2; namely, the permanent magnet 61 has a pole surface facing to and spaced from the stator 2. In operation, the hub 6 can be driven to rotate by the magnetic field generated by the stator 2.

In sum, with the above structure that the pressing member 5 disposed in the bearing sleeve 11 can press and position the thrust bearing 4, the thrust bearing 4 is firmly coupled inside the bearing sleeve 11 without any movement in operation. Accordingly, the thrust bearing 4 can surely delimit the limiting portion 32 to avoid the rotating member 3 disengaging from the bearing sleeve 11 via the opening end 111. Furthermore, the pressing member 5 can also provide additional function such as oil preservation. As a result, the disclosed motor not only enhances the combination stability of the thrust bearing. 4, but also prolongs the lifetime by the improved oil preservation.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A motor with thrust bearing, comprising:
a base having a bearing sleeve, with the bearing sleeve having an opening end and a sealing end, with the opening and sealing ends opposite to each other;
a stator coupled with the base;
a rotating member rotatably received in and coupled with the bearing sleeve, with the rotating member comprising a shaft and a limiting portion, wherein a first end of the shaft connects with the limiting portion, a second end of the shaft has a coupling portion;
a thrust bearing arranged between the shaft and an inner surface of the bearing sleeve, so that the limiting portion is between the thrust bearing and the sealing end;
a pressing member coupled with the bearing sleeve and received therein for positioning the thrust bearing; and
a hub coupled with the coupling portion of the shaft and having a permanent magnet corresponding to the stator.

2. The motor with thrust bearing as claimed in claim 1, wherein a support is mounted in the bearing sleeve and between the thrust bearing and the sealing end, with the thrust bearing abutting against the support.

3. The motor with thrust bearing as claimed in claim 2, wherein a gap is formed between the limiting portion and the thrust bearing.

4. The motor with thrust bearing as claimed in claim 2, wherein the support is in a ring shape and surrounds the limiting portion, and a gap is formed between the limiting portion and an inner surface of the support.

5. The motor with thrust bearing as claimed in claim 2, wherein the support is integrally formed with an end face of the thrust bearing.

6. The motor with thrust bearing as claimed in claim 2, wherein the support is integrally formed with the inner surface of the bearing sleeve.

7. The motor with thrust bearing as claimed in claim 2, wherein the sealing end has a groove in the bearing sleeve, and the support is mounted in the groove.

8. The motor with thrust bearing as claimed in claim 1, wherein the pressing member is in a plate shape and coupled with the inner surface of the bearing sleeve by press fit.

9. The motor with thrust bearing as claimed in claim 8, wherein an axial height of the pressing member is smaller than or equal to an axial height of the limiting portion.

10. The motor with thrust bearing as claimed in claim 1, wherein the pressing member has a plate and an annular flange, the annular flange connects with an outer edge of the plate and engages with the inner surface of the bearing sleeve by press fit.

11. The motor with thrust bearing as claimed in claim 10, wherein an axial height of the annular flange is larger than or equal to an axial height of the limiting portion.

12. The motor with thrust bearing as claimed in claim 1, wherein, in radial directions of the rotating member, each of the shaft and the limiting portion has a maximum outer diameter, and the maximum outer diameter of the limiting portion is larger than the maximum outer diameter of the shaft.

13. The motor with thrust bearing as claimed in claim 1, wherein the base further has a plate integrally formed with the bearing sleeve.

14. The motor with thrust bearing as claimed in claim 1, wherein the base further has a plate connecting with the bearing sleeve detachably.

15. The motor with thrust bearing as claimed in claim 1, wherein a wear pad is disposed in the bearing sleeve on an inner side of the sealing end, and the rotating member abuts against the wear pad.
